(19) United States
(12) Patent Application Publication
(10) Pub. No.: US 2018/0128644 A1
(43) Pub. Date: May 10, 2018

(54) METHOD AND APPARATUS FOR ORIENTATION OF INERTIAL MEASUREMENT UNIT

(71) Applicant: Bennett Marine, Inc., Deerfield Beach, FL (US)

(72) Inventors: Steven M Lurcott, Lighthouse Point, FL (US); John Douglas Wulf, Boca Raton, FL (US)

(21) Appl. No.: 15/723,754

(22) Filed: Oct. 3, 2017

Related U.S. Application Data
(60) Provisional application No. 62/403,593, filed on Oct. 3, 2016.
(60) Provisional application No. 62/459,145, filed on Feb. 15, 2017.

(51) Int. Cl. G01C 25/00; G01P 21/00

(52) U.S. Cl. CPC G01C 25/005; G01P 21/00

(57) ABSTRACT

A method and apparatus for orientation of an inertial measurement unit is provided wherein an inertial measurement unit in the form of an automated trim tab control unit may be re-oriented to coincide with the orientation of a vessel allowing it to be installed in any orientation on the vessel. The control unit may have one or more sensors, including at least one accelerometer, at least one gyroscope, and at least one magnetometer. Having sensed and or calculated the direction of three new prime axes, the control unit can define a second coordinate system. Using the defined second coordinate system, the control unit can calculate a correction to translate a first coordinate system to the second coordinate system, thus orienting the control unit to the vessel.

### CLAIM OF PRIORITY

This application is being filed as a non-provisional patent application under 35 U.S.C. § 111(a) and 37 CFR § 1.53(b). This application claims priority under 35 U.S.C. § 119(e) to U.S. provisional patent applications Ser. No. 62/403,593 filed on Oct. 3, 2016, and Ser. No. 62/459,145 filed on Feb. 15, 2017, the contents of which are incorporated herein by reference.

### FIELD OF INVENTION

The invention relates generally to the orientation of inertial measurement units, such as an automated trim tab control system, and in particular to a system and method for orienting a trim tab control unit, or other inertial measurement unit, to the orientation of a vessel to allow for ease of mounting on the vessel.

### BACKGROUND OF THE INVENTION

Automated trim tab systems are employed on power boats for selectively adjusting or trimming boat attitude under varying load and sea conditions as the boat is powered through the water. Trim tabs are pivotally mounted at laterally spaced positions on the boat stern. A control unit is utilized to selectively adjust positions of the respective trim tabs independently of each other.

Existing automated trim tabs systems require the user to orient the control unit such that the physical mounting of the control unit in the boat aligns with the coordinate system of the accelerometer and the gyroscope with the boat's coordinate system. This way the movements that are sensed by the accelerometer and the gyroscope can be properly translated to the proper movements to control the trim tabs, and this the attitude of the boat.

An underlying problem with current automated trim tab systems is that the control unit must be installed in a specific orientation on the boat so that the orientation of the control unit will coincide with the orientation of the boat.

Accordingly, the current invention aims to provide a control unit that may be mounted in any orientation in the boat. The ability to install the control unit in any orientation provides a great advantage for ease of installation in the boat.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

According to one implementation, an automated trim tab system utilizes a control unit having one or more sensors, including at least one accelerometer, at least one gyroscope, and at least one magnetometer. The at least one accelerometer, the at least one gyroscope, and the at least one magnetometer maintain the same orientation wherein a first coordinate system is defined having an X-axis, a Y-axis, and a Z-axis.

The control unit may be re-oriented to coincide with the orientation of the boat. While the boat is at rest, a user can enter a set-up mode to orient the control unit to the boat's coordinate system. Once in set-up mode, the at least one accelerometer of the control unit will sense the direction of gravity relative to the installed control unit. Once the control unit determines the direction of gravity, the boat will need to accelerate in a linear direction so that the control unit has an indication of where the bow is positioned relative to the control unit. In an alternative implementation, the at least one magnetometer of the control unit can sense direction in a plane perpendicular to the direction of gravity, rather than waiting for the boat to linearly accelerate before sensing direction.

Upon sensing the direction of gravity and the direction of acceleration, the control unit can calculate a direction that is normal to the direction of gravity and the direction of acceleration. Having sensed and or calculated the direction of three new prime axes, the control unit can define a second coordinate system. Using the defined second coordinate system, the control unit can calculate a correction to translate the first coordinate system to the second coordinate system, thus orienting the control unit to the boat.

Although the invention is illustrated and described herein as implemented in connection with an automated trim tab control system, it is nevertheless not intended to be limited to only the details shown, since various modifications and structural changes may be made therein without departing from the spirit of the invention and within the scope and range of equivalents of the claims.

These and other features and advantages will be apparent from a reading of the following detailed description, and a review of the appended drawings. It is to be understood that the foregoing summary, the following detailed descriptions, and the appended drawings are only explanatory and are not restrictive of various aspects claimed.

### BRIEF DESCRIPTION OF THE DRAWINGS

FIGS. 1A-1B are illustrations of a control unit having a first coordinate system and an exemplary computing environment in accordance with an implementation of the invention.

FIG. 2 is an isometric view of a control unit mounted on a vessel pointed to a pre-determined direction in accordance with an implementation of the invention.

FIGS. 3A-3C are a flowchart and various views illustrating the method of orienting the control unit in accordance with an implementation of the invention.

FIG. 4 illustrates a second coordinate system in accordance with an implementation of the invention.

FIG. 5 is a flowchart illustrating a pitch threshold for detecting acceleration in accordance with an implementation of the invention.

### DETAILED DESCRIPTION OF THE INVENTION

Although the following detailed description of the invention is illustrated and described herein as implemented in an automated trim tab control system, those of skill in the art will recognize that the disclosed method and system can be used in connection with any other device, including an inertial measurement unit, on a vessel which requires awareness of its orientation with respect to the vessel or vehicle where it is installed.

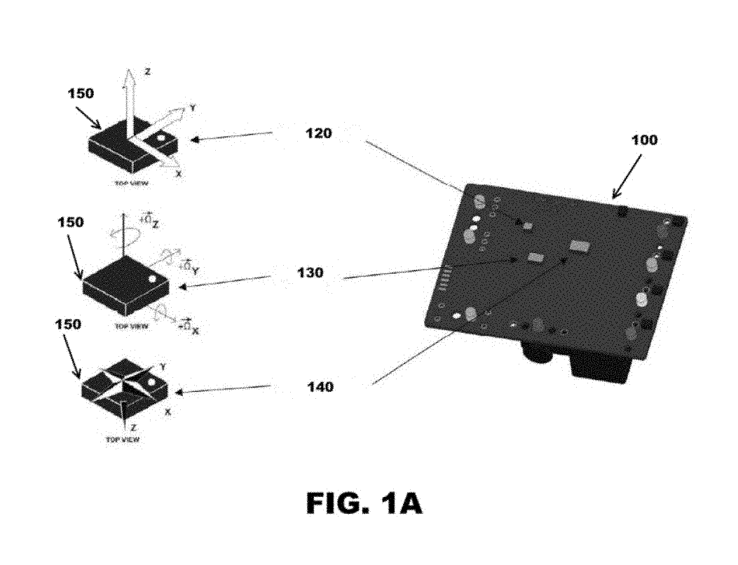

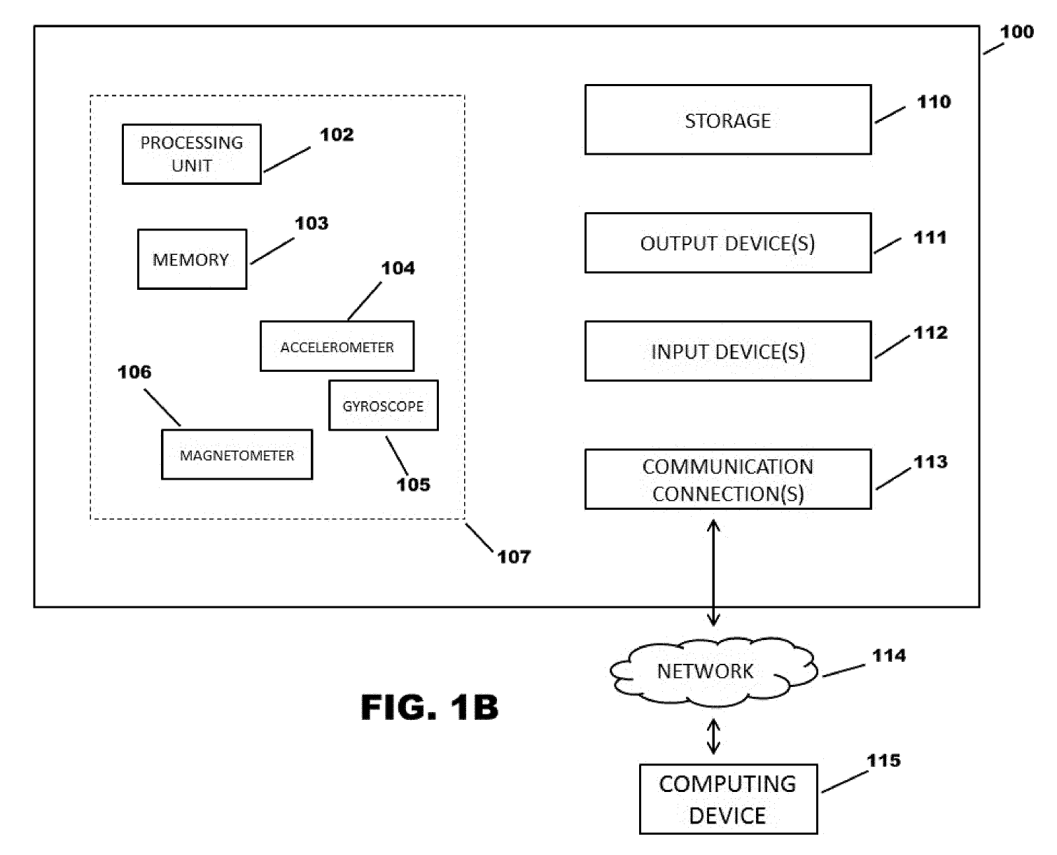

FIG. 1A shows an example implementation of an automatic trim tab system having an inertial measurement unit in the form of a control unit 100 having one or more sensors. Preferably, the one or more sensors of the control unit 100 are comprised of at least one accelerometer 120, at least one gyroscope 130, and at least one magnetometer 140. The at least one accelerometer 120, the at least one gyroscope 130, and the at least one magnetometer 140 maintain the same orientation wherein a first coordinate system 150 is defined having an X-axis, a Y-axis, and a Z-axis. During manufacture, the orientation data including the first coordinate system 150 is stored during mounting of the at least one accelerometer 120, the at least one gyroscope 130, and the at least one magnetometer 140 onto a specific location on the control unit 100.

The control unit may utilize the at least one accelerometer 120 and the at least one gyroscope 130 to sense the attitude (pitch and roll) of a vessel. Additionally, the at least one magnetometer 140 may measure the angle between its known orientation to the at least one accelerometer 120 and the at least one gyroscope 130, and the position of the vessel when the vessel is placed in a specific pre-determined location.

FIG. 1B and the following discussion provide a brief, general description of a suitable computing environment to implement implementations of one or more of the provisions set forth herein. The operating environment of FIG. 1B is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, embedded systems, distributed computing environments that include any of the above systems or devices, and the like.

Although not required, implementations are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 1B illustrates an example of a system 170 comprising a control unit 100 configured to implement one or more implementations provided herein. In one implementation, the control unit 100 includes at least one processing unit 102 at least one memory 103, at least one accelerometer 104, at least one gyroscope 105, and at least one magnetometer 106. Depending on the exact configuration and type of control unit 100, memory 103 may be volatile (such as RAM, for example), non-volatile (such as ROM, flash memory, etc., for example) or some combination of the two. This configuration is illustrated in FIG. 1B by dashed line 107.

In other implementations, control unit 100 may include additional features and/or functionality. For example, control unit 100 may also include additional storage (e.g., removable and/or non-removable) including, but not limited to, magnetic storage, optical storage, and the like. Such additional storage is illustrated in FIG. 1B by storage 110. In one implementation, computer readable instructions used to implement one or more implementations provided herein may be in storage 110. Storage 110 may also store other computer readable instructions to implement an operating system, an application program, and the like. Computer readable instructions may be loaded in memory 103 for execution by processing unit 102, for example.

The term “computer readable media” as used herein includes computer storage media. Computer storage media includes volatile and nonvolatile, removable and non-removable media implemented in any method or technology for storage of information such as computer readable instructions or other data. Memory 103 and storage 110 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by control unit 100. Any such computer storage media may be part of control unit 100.

Control unit 100 may also include communication connection(s) 113 that allows control unit 100 to communicate with other devices. Communication connection(s) 113 may include, but is not limited to, a modem, a Network Interface Card (NIC), an integrated network interface, a radio frequency transmitter/receiver, an infrared port, a USB connection, or other interfaces for connecting control unit 100 to other computing devices. Communication connection(s) 113 may include a wired connection or a wireless connection. Communication connection(s) 113 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Control unit 100 may include input device(s) 112 such as keyboard, mouse, pen, voice input device, touch input device, infrared cameras, video input devices, and/or any other input device. Output device(s) 111 such as one or more displays, speakers, printers, and/or any other output device may also be included in control unit 100. Input device(s) 112 and output device(s) 111 may be connected to control unit 100 via a wired connection, wireless connection, or any combination thereof. In one implementation, an input device or an output device from another computing device may be used as input device(s) 112 or output device(s) 111 for control unit 100.

Components of control unit 100 may be connected by various interconnects, such as a bus, like, for example, an NMEA2000 Can Bus. Such interconnects may include a Peripheral Component Interconnect (PCI), such as PCI Express, a Universal Serial Bus (USB), firewire (IEEE 1394), an optical bus structure, and the like. In another implementation, components of control unit 100 may be interconnected by a network. For example, memory 103 may be comprised of multiple physical memory units located in different physical locations interconnected by a network.

Those skilled in the art will realize that storage devices utilized to store computer readable instructions may be distributed across a network. For example, a computing device 115 accessible via network 114 may store computer readable instructions to implement one or more implementations provided herein. Control unit 100 may access computing device 115 and download a part or all of the computer readable instructions for execution. Alternatively, computing device 115 may download pieces of the computer readable instructions, as needed, or some instructions may be executed at control unit 100 and some at computing device 115.

The control unit 100 may be fixed inside a waterproof and shockproof housing, allowing it to be attached onto any interior or exterior surface of a vessel. In a preferred implementation, the vessel is a boat; however, the control unit 100 can be attached to any vessel to control the pitch of an actuated fluid spoiler or the like. Although the control unit 100 is manufactured to include a predefined first coordinate system 150 (as discussed with respect to FIG. 1A), the control unit 100 may be re-oriented to a second coordinate system, allowing a user to install the control unit in any orientation on the vessel.

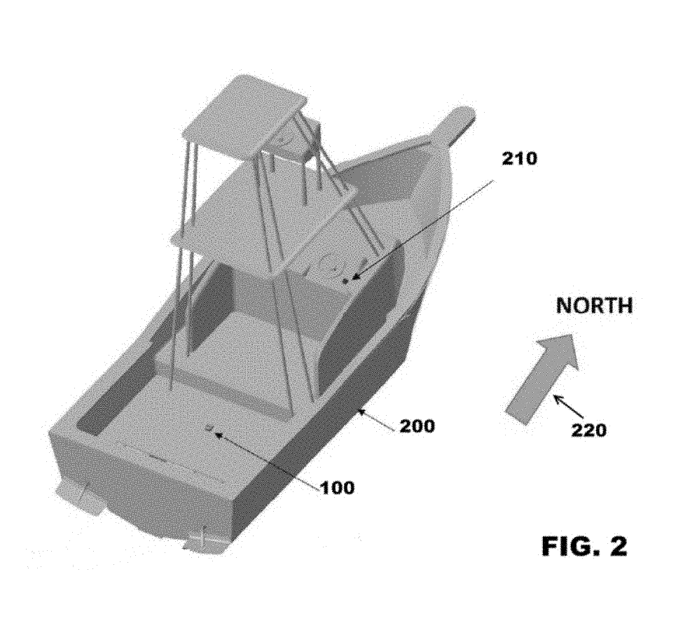

FIG. 2 illustrates an example installation of the control unit onto a vessel. In FIG. 2, the control unit 100 is installed toward the stern of a boat 200; however, the control unit 100 may be installed in any orientation on the boat 200. The control unit 100 may be re-oriented to coincide with the orientation of the boat 200. For example, the bow of the boat 200 is facing a pre-determined direction—depicted in FIG. 2 as north 220. Depending on the installation of the control unit 100, the orientation of the first coordinate system 150 (with respect to FIG. 1A) may not coincide with the orientation of the boat's 100 coordinate system, resulting in severely decreased performance of automatic trim tab control.

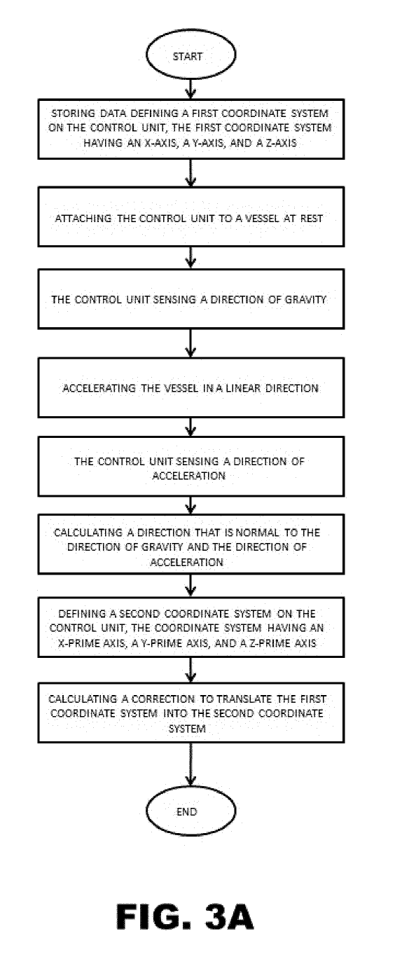

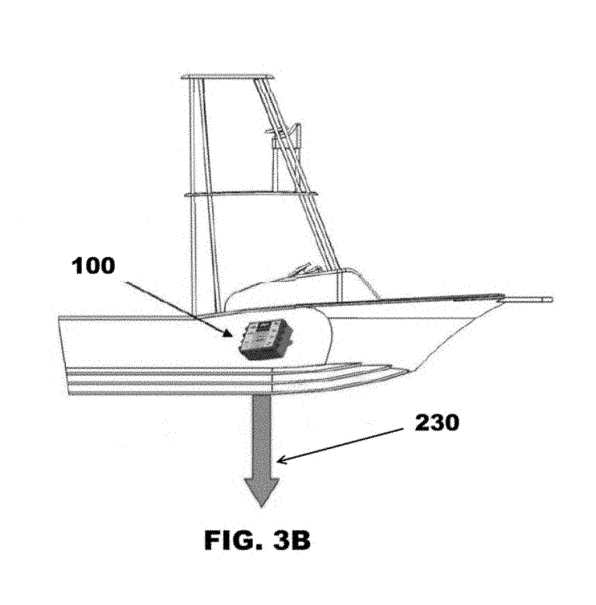

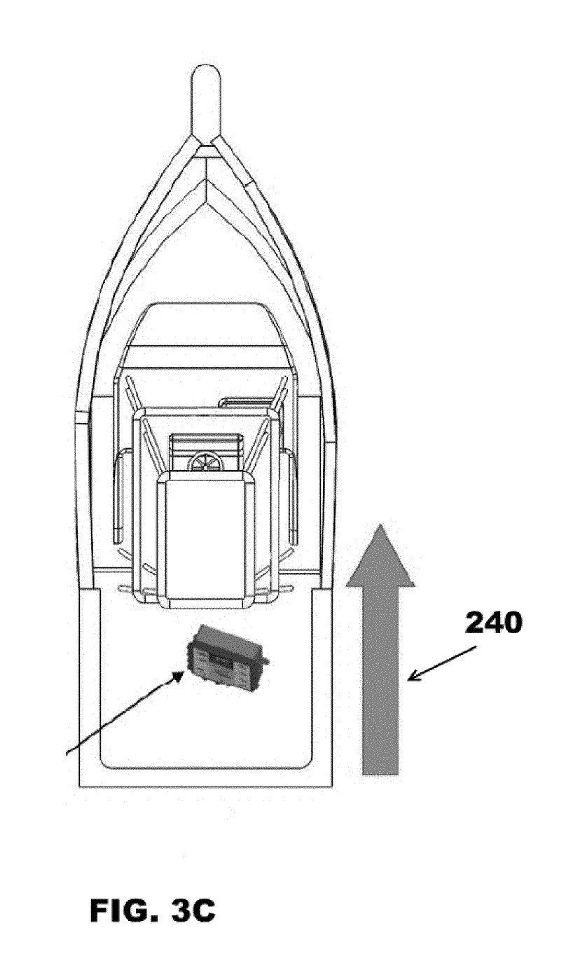

FIG. 3A illustrates an exemplary method for re-orienting the control unit. Referring to FIGS. 2 & 3A, while the boat 200 is at rest, a user can enter a set-up mode using a user interface of a computing device 210 to orient the control unit 100 to the boat's 200 coordinate system. Once in set-up mode, the at least one accelerometer of the control unit 100 will sense the direction of gravity relative to the installed control unit 100. As shown in FIG. 3B, the control unit 100 installed on the boat 200 detects the direction of gravity 230. The control unit 100 will utilize the direction of gravity 230 to form a first new prime axis (explained in greater detail below).

Referring to FIGS. 3A & 3C, once the control unit determines the direction of gravity 230, the boat 200 will need to accelerate in a linear direction so that the control unit 100 has an indication of where the bow is positioned relative to the control unit 100. In an alternative implementation, the at least one magnetometer of the control unit 100 can sense direction in a plane perpendicular to the direction of gravity 230, rather than waiting for the boat to linearly accelerate before sensing direction. However, linear acceleration will provide the control unit 100 with more accurate readings. After the direction of gravity is established the boat may be oriented to north based on a compass of the boat. The user may signal to the control unit that the boat is oriented north, wherein the control unit's magnetometer can measure the direction of north and calculate the second coordinate system.

The control unit 100 will utilize the direction of acceleration 240 to form a second new prime axis (explained in greater detail below). Upon sensing the direction of gravity 230 and the direction of acceleration 240, the control unit can calculate a direction that is normal to the direction of gravity 230 and the direction of acceleration 240. The control unit 100 will utilize the calculated direction to form a third new prime axis.

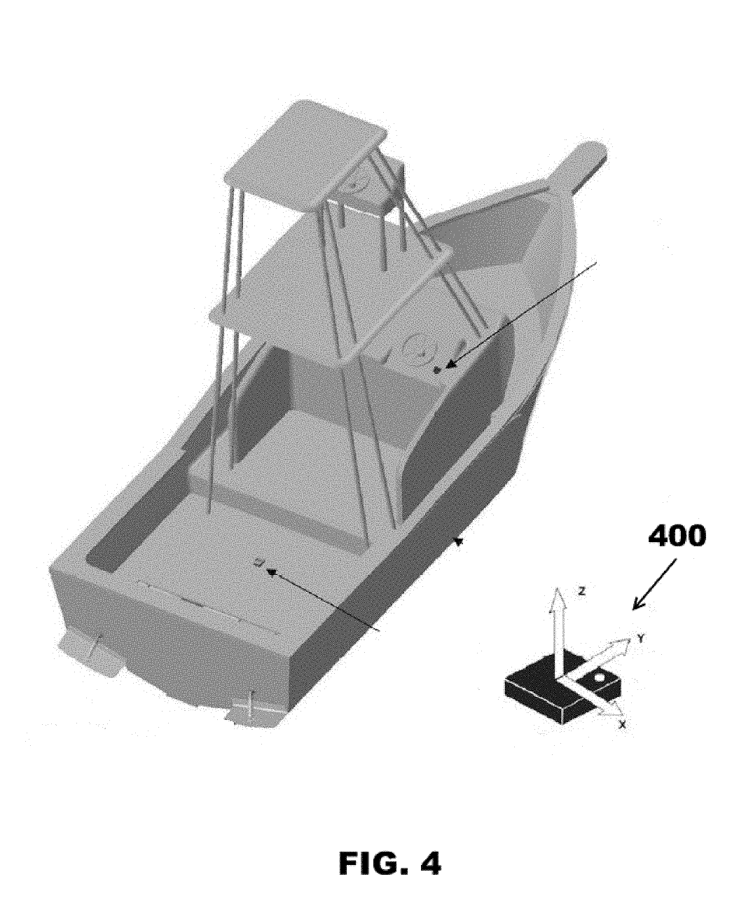

As shown in FIG. 4, having sensed and or calculated the direction of three new prime axes, the control unit 100 can now define a second coordinate system 400 having an X-prime axis 420, a Y-prime axis 440, and a Z-prime axis 460. The X-prime axis 420 is coincident with the calculated direction, the Y-prime axis 440 is coincident with the sensed direction of acceleration, and the Z-prime axis 460 is coincident with the sensed direction of gravity. Using the defined second coordinate system, the control unit can calculate a correction to translate the first coordinate system to the second coordinate system 400, thus orienting the control unit to the boat.

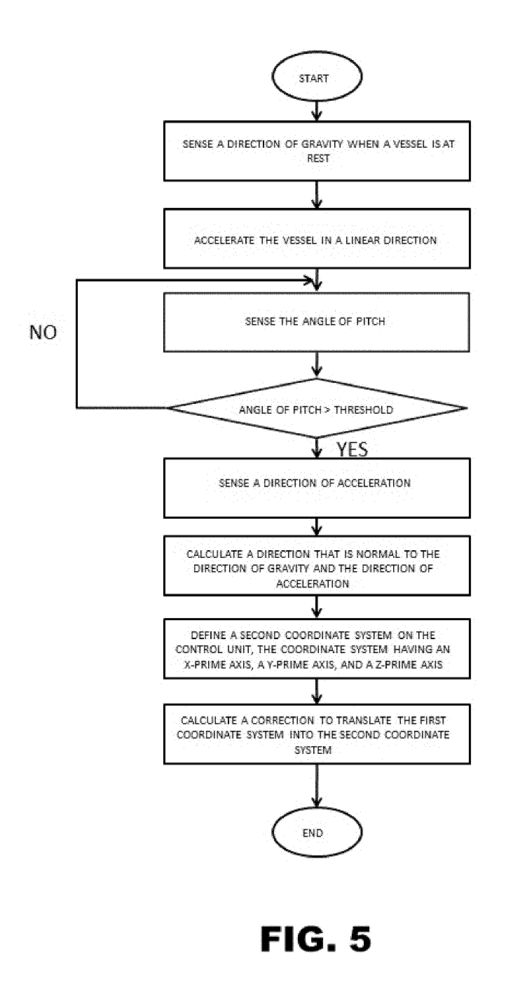

Referring to FIG. 5, in another implementation, the control unit may detect the angle of pitch of the bow before re-orienting the control unit. As the boat accelerates from rest, the angle of pitch of the bow will increase. When the angle of pitch is above a certain threshold, the control unit will begin to detect acceleration, wherein the accelerometer will sense a direction of acceleration.

The following discussion provides a brief, general mathematical description in accordance with previously described implementations of a method for orienting the control unit. This mathematical description is for illustrative purposes and such a description should not limit the invention or any implementation of the invention. A mathematical description will be appreciated by one skilled in the art having the benefit of this description.

When we first orient the control unit, the control unit senses the vector g in the direction of gravity. The vector g lies in the direction of the z axis in our new coordinate system. To define the z-component of our new coordinate basis the control unit will use a normalized vector in the direction opposite of g—that is:

$${k}^{′} = \frac{\vec{g}}{\vert \vec{g} \vert} .$$

The control unit will sense the vector n, in a northerly direction. The projection of n onto the plane perpendicular to k′ will lie on the positive y-axis of our new coordinate system. We will call this vector n′: [symbol] = [symbol] × [symbol] × [symbol] .

While the direction of n′ is correct, its magnitude is not the true magnitude of the projection of n onto the second coordinate x-y plane. This is irrelevant, however, because the control unit only needs a unit vector in the direction of n′ to define the y-component of the second coordinate system—that is:

$${j}^{′} = \frac{\vec{{n}^{′}}}{\vert \vec{{n}^{′}} \vert} .$$

To find the x-component of the second coordinate system the control unit simply takes the cross product of j′ and k′ (i.e., i′=j′×k′).

The unit vectors i′, j′ and k′ form a basis, B, for a three-dimensional space (i.e., B=[i′ j′ k′]).

The inverse of an orthogonal matrix is its transpose so the correction is:

$${B}^{- 1} = [ \begin{matrix}{i}_{1} & {i}_{2} & {i}_{3} \\ {j}_{1} & {j}_{2} & {j}_{3} \\ {k}_{1} & {k}_{2} & {k}_{3}\end{matrix} ] .$$

The inverse of a base is also the change of basis matrix from the first coordinate system to the second coordinate system. Therefore, for any vector v given by the one or more sensors of the control unit, the control unit can translate it to a vector, v′, in the second coordinate system with the following formula: [symbol] =B⁻¹ [symbol] .

Any reference in this specification to “one implementation,” “an implementation,” an “example implementation,” etc., means that a particular feature, structure, or characteristic described in connection with the implementation is included in at least one implementation of the invention. The appearances of such phrases in various places in the specification are not necessarily referring to the same implementation. In addition, any elements or limitations of any invention or implementation thereof disclosed herein can be combined with any and/or all other elements or limitations (individually or in any combination) or any invention or implementation thereof disclosed herein, and all such combinations are contemplated with the scope of the invention without limitation thereto.

It should be understood that the examples and implementations described herein are for illustrative purposes only and that various modifications or changes in light thereof will be suggested to persons skilled in the art and are to be included within the spirit and purview of this application.

1. A method for orienting an inertial measurement unit, the method comprising:
storing data defining a first coordinate system on the inertial measurement unit, the first coordinate system having an X-axis, a Y-axis, and a Z-axis.
attaching the inertial measurement unit to a vessel at rest;
the inertial measurement unit sensing a direction of gravity;
accelerating the vessel in a linear direction;
the inertial measurement unit sensing a direction of acceleration;
calculating a direction that is normal to the direction of gravity and the direction of acceleration;
defining a second coordinate system on the inertial measurement unit, the coordinate system having an X-prime axis, a Y-prime axis, and a Z-prime axis;
wherein the X-prime axis is coincident with the calculated direction;
wherein the Y-prime axis is coincident with the direction of acceleration;
wherein the Z-prime axis is coincident with the direction of gravity;
calculating a correction to translate the first coordinate system into the second coordinate system.

2. The method of claim 1, wherein the inertial measurement unit is an automated trim tab control unit.

3. The method of claim 1, wherein the vessel is a boat.

4. The method of claim 1, wherein the inertial measurement unit senses the direction of gravity and the direction of acceleration with at least one accelerometer.

5. The method of claim 1, wherein the inertial measurement unit senses an angle of pitch of a bow of a vessel, wherein the inertial measurement unit will begin to sense the direction of acceleration if the angle of pitch is greater than a threshold.

6. The method of claim 4, wherein the at least one accelerometer or at least one gyroscope can measure the angle of pitch.

7. The method of claim 1, wherein the vessel is oriented to north based on a compass of a vessel.

8. The method of claim 1, wherein a user may signal to the inertial measurement unit that the vessel is oriented north, wherein the inertial measurement unit may utilize at least one magnetometer to measure the direction of north and calculate the second coordinate system.

9. An automated trim tab control system, comprising:
an inertial measurement unit, comprising:
a processing unit;
one or more computer readable storage media;
one or more sensors;
program instructions stored on at least one of the one or more storage media that, when executed by the processing unit, direct the processing unit to:
store data defining a first coordinate system on the inertial measurement unit, the first coordinate system having an X-axis, a-Y axis, and a Z-axis.
sense a direction of gravity when a vessel is at rest;
sense a direction of acceleration upon the acceleration of the vessel in a linear direction;
calculate a direction that is normal to the direction of gravity and the direction of acceleration;
define a second coordinate system on the inertial measurement unit, the coordinate system having an X-prime axis, a Y-prime axis, and a Z-prime axis;
wherein the X-prime axis is coincident with the calculated direction;
wherein the Y-prime axis is coincident with the direction of acceleration;
wherein the Z-prime axis is coincident with the direction of gravity;
calculate a correction to translate the first coordinate system into the second coordinate system.

10. The method of claim 9, wherein the inertial measurement unit is an automated trim tab control unit.

11. The method of claim 9, wherein the vessel is a boat.

12. The method of claim 9, wherein the one or more sensors are comprised of at least:
an accelerometer;
a gyroscope;
or a magnetometer.

13. The method of claim 9, wherein the one or more sensors senses the direction of gravity and the direction of acceleration with at least one accelerometer.

14. The method of claim 9, wherein the one or more sensors senses an angle of pitch of a bow of a vessel, wherein the one or more sensors will begin to sense the direction of acceleration if the angle of pitch is greater than a threshold.

15. The method of claim 14, wherein the one or more sensors can measure the angle of pitch.

16. The method of claim 9, wherein the vessel is oriented to north based on a compass of a vessel.

17. The method of claim 9, wherein a user may signal to the inertial measurement unit that the vessel is oriented north, wherein the inertial measurement unit may utilize at least one of the one or more sensors to measure the direction of north and calculate the second coordinate system.

18. A computer readable medium comprising instructions that when executed perform a method for orienting an inertial measurement unit, comprising:
storing data defining a first coordinate system on an inertial measurement unit, the first coordinate system having an X-axis, a Y-axis, and a Z-axis.
the inertial measurement unit sensing a direction of gravity;
the inertial measurement unit sensing a direction of acceleration;
calculating a direction that is normal to the direction of gravity and the direction of acceleration;
defining a second coordinate system on the inertial measurement unit, the coordinate system having an X-prime axis, a Y-prime axis, and a Z-prime axis;
wherein the X-prime axis is coincident with the calculated direction;
wherein the Y-prime axis is coincident with the direction of acceleration;
wherein the Z-prime axis is coincident with the direction of gravity;
calculating a correction to translate the first coordinate system to the second coordinate system.

19. The method of claim 18, wherein the inertial measurement unit is an automated trim tab control unit.

20. The method of claim 18, wherein the vessel is a boat.

21. The method of claim 18, wherein the inertial measurement unit senses the direction of gravity and the direction of acceleration with at least one accelerometer.

22. The method of claim 18, wherein the inertial measurement unit senses an angle of pitch of a bow of a vessel, wherein the inertial measurement unit will begin to sense the direction of acceleration if the angle of pitch is greater than a threshold.

23. The method of claim 22, wherein the at least one accelerometer or at least one gyroscope can measure the angle of pitch.

24. The method of claim 18, wherein the vessel is oriented to north based on a compass of a vessel.

25. The method of claim 18, wherein a user may signal to the inertial measurement unit that the vessel is oriented north, wherein the inertial measurement unit may utilize at least one magnetometer to measure the direction of north and calculate the second coordinate system.
